(19) United States
(12) Patent Application Publication
(10) Pub. No.: US 2013/0147574 A1
(43) Pub. Date: Jun. 13, 2013

(54) NON-RECIPROCAL CIRCUIT ELEMENT

(71) Applicant: MURATA MANUFACTURING CO., LTD., Nagaokakyo-shi (JP)

(72) Inventor: Takaya WADA, Nagaokakyo-shi (JP)

(73) Assignee: MURATA MANUFACTURING CO., LTD., Nagaokakyo-shi (JP)

(21) Appl. No.: 13/761,951

(22) Filed: Feb. 7, 2013

Related U.S. Application Data
(63) Continuation of application No. PCT/JP2011/065249, filed on Jul. 4, 2011.

(30) Foreign Application Priority Data
Aug. 9, 2010 (JP) 2010-178444

(51) Int. Cl. H01P 1/36

(52) U.S. Cl. CPC H01P 1/36
USPC 333/24.2

(57) ABSTRACT

In a non-reciprocal circuit element, a first center electrode and a second center electrode are disposed in a ferrite so as to intersect with each other in an insulated state. The ferrite receives a direct-current magnetic field from a permanent magnet. One end of the first center electrode is connected to a first port, the other end thereof is connected to a second port, one end of the second center electrode is connected to the second port, and the other end thereof is connected to a third port. Between the first and second ports, a terminating resistor and a capacitance-variable capacitor are connected in parallel to the first center electrode. By changing the capacitance value of the capacitor, the isolation frequency is adjusted.

### BACKGROUND OF THE INVENTION

1. Field of the Invention

The present invention relates to a non-reciprocal circuit element, and, in particular, a non-reciprocal circuit element such as an isolator or a circulator, used in microwave bands.

2. Description of the Related Art

In the past, non-reciprocal circuit elements such as an isolator and a circulator have had a characteristic of only transmitting a signal in a predetermined direction and not transmitting a signal in an reverse direction. Using this characteristic, for example, the isolator is used in a transmission circuit unit in a mobile communication device such as an automobile telephone or a cellular phone.

As described in Japanese Unexamined Patent Application Publication No. 2008-85981, as a non-reciprocal circuit element of this kind, a non-reciprocal circuit element has been described where, so as to obtain a sufficient isolation characteristic in an arbitrary frequency band, a first variable matching mechanism is series-connected to each of a plurality of matching capacitors and the reactance of the first variable matching mechanism is changed.

However, in this non-reciprocal circuit element, since a high-frequency wave current passes through the first variable matching mechanism when the high-frequency wave current is input in a forward direction, there is a problem that an insertion loss inevitably increases.

### SUMMARY OF THE INVENTION

Therefore, preferred embodiments of the present invention provide a non-reciprocal circuit element capable of adjusting an isolation frequency without deteriorating an insertion loss.

A non-reciprocal circuit element according to a first preferred embodiment of the present invention includes a permanent magnet, a ferrite to which a direct-current magnetic field generated by the permanent magnet is applied, a plurality of center electrodes disposed in the ferrite so as to intersect with each other in an insulated state, a terminating resistor connected in parallel to one of the center electrodes between input-output ports, and a capacitance mechanism including a capacitance connected to the terminating resistor between the input-output ports that is variable.

In the non-reciprocal circuit element according to the first preferred embodiment of the present invention, when a high-frequency wave current is input in an inverse direction, the high-frequency wave current is attenuated (isolation) by a parallel resonance circuit defined by the center electrode connected in parallel to the terminating resistor and the capacitance mechanism whose capacitance is variable. By changing the capacitance value of the capacitance mechanism, an isolation frequency is adjusted. In addition, by selecting the impedance of the terminating resistor, an attenuation is adjusted. On the other hand, when a high-frequency signal is input in a forward direction, a large high-frequency wave current flows in the center electrode to which no terminating resistor is connected, and high-frequency wave currents hardly flow in the terminating resistor and the capacitance mechanism. Therefore, even if the capacitance mechanism is added, a loss due thereto is negligible, and an insertion loss does not increase.

A non-reciprocal circuit element according to a second preferred embodiment of the present invention includes a permanent magnet, a ferrite to which a direct-current magnetic field generated by the permanent magnet is applied, and a first center electrode and a second center electrode disposed in the ferrite so as to intersect with each other in an insulated state, wherein one end of the first center electrode is electrically connected to an input port and the other end thereof is electrically connected to an output port, one end of the second center electrode is electrically connected to an output port and the other end thereof is electrically connected to a ground port, a terminating resistor is electrically connected between the input port and the output port, a capacitance mechanism including a capacitance that is variable is connected in parallel to the terminating resistor between the input port and the output port, and a matching capacitance is electrically connected between the output port and the ground port.

In the non-reciprocal circuit element according to the second preferred embodiment of the present invention, when a high-frequency wave current is input from the output port, the high-frequency wave current is attenuated (isolation) by a parallel resonance circuit defined by the first center electrode and the capacitance mechanism whose capacitance is variable. By changing the capacitance value of the capacitance mechanism, an isolation frequency is adjusted. In addition, by selecting the impedance of the terminating resistor, an attenuation is adjusted. On the other hand, at the time of an operation where a high-frequency wave current flows from the input port to the output port, a large high-frequency wave current flows in the second center electrode, and high-frequency wave currents hardly flow in the terminating resistor and the capacitance mechanism. Therefore, even if the capacitance mechanism is added, a loss due thereto is negligible, and an insertion loss does not increase.

A non-reciprocal circuit element according to a third preferred embodiment of the present invention includes a permanent magnet, a ferrite to which a direct-current magnetic field generated by the permanent magnet is applied, and a first center electrode and a second center electrode disposed in the ferrite so as to intersect with each other in an insulated state, wherein one end of the first center electrode is electrically connected to an input port and the other end thereof is electrically connected to an output port, one end of the second center electrode is electrically connected to an output port and the other end thereof is electrically connected to a ground port, a first matching capacitance is electrically connected between the input port and the output port, a second matching capacitance is electrically connected between the output port and the ground port, a terminating resistor is electrically connected between the input port and the output port, and a capacitance mechanism including a capacitance that is variable is connected in parallel to the terminating resistor between the input port and the output port.

In the non-reciprocal circuit element according to the third preferred embodiment of the present invention, when a high-frequency wave current is input from the output port, the high-frequency wave current is attenuated (isolation) by a parallel resonance circuit defined by the first center electrode, the first matching capacitance, and the capacitance mechanism whose capacitance is variable. By changing the capacitance value of the capacitance mechanism, an isolation frequency is adjusted. In addition, by selecting the impedance of the terminating resistor, an attenuation is adjusted. On the other hand, at the time of an operation where a high-frequency wave current flows from the input port to the output port, a large high-frequency wave current flows in the second center electrode, and high-frequency wave currents hardly flow in the terminating resistor and the capacitance mechanism. Therefore, even if the capacitance mechanism is added, a loss due thereto is negligible, and an insertion loss does not increase.

According to various preferred embodiments of the present invention, it is possible to adjust an isolation frequency without deteriorating an insertion loss characteristic.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is an equivalent circuit diagram illustrating a non-reciprocal circuit element according to a first preferred embodiment of the present invention.

FIG. 2 is an equivalent circuit diagram illustrating a non-reciprocal circuit element according to a second preferred embodiment of the present invention.

FIG. 3 is an equivalent circuit diagram illustrating a non-reciprocal circuit element according to a third preferred embodiment of the present invention.

FIG. 4 is an equivalent circuit diagram illustrating a non-reciprocal circuit element serving according to a fourth preferred embodiment of the present invention.

FIG. 5 is a perspective view illustrating an example 1 of a configuration of the non-reciprocal circuit element according to the second preferred embodiment of the present invention.

FIG. 6 is a perspective view illustrating an example 2 of a configuration of the non-reciprocal circuit element according to the second preferred embodiment of the present invention.

FIG. 7 is an exploded perspective view illustrating a ferrite-magnet element.

FIG. 8 is a perspective view illustrating a ferrite with a center electrode.

FIG. 9 is a Smith chart illustrating input matching characteristics of the non-reciprocal circuit element according to the second preferred embodiment of the present invention.

FIG. 10 is a graph illustrating an insertion loss of the non-reciprocal circuit element serving according to the second preferred embodiment of the present invention.

FIG. 11 is a graph illustrating an isolation characteristic of the non-reciprocal circuit element according to the second preferred embodiment of the present invention.

FIG. 12 is a Smith chart illustrating output matching characteristics of the non-reciprocal circuit element according to the second preferred embodiment of the present invention.

FIG. 13 is a Smith chart illustrating input matching characteristics of the non-reciprocal circuit element according to the fourth preferred embodiment of the present invention.

FIG. 14 is a graph illustrating an insertion loss of the non-reciprocal circuit element according to the fourth preferred embodiment of the present invention.

FIG. 15 is a graph illustrating an isolation characteristic of the non-reciprocal circuit element according to the fourth preferred embodiment of the present invention.

FIG. 16 is a Smith chart illustrating output matching characteristics of the non-reciprocal circuit element according to the fourth preferred embodiment of the present invention.

### DETAILED DESCRIPTION OF THE PREFERRED EMBODIMENTS

Hereinafter, preferred embodiments of a non-reciprocal circuit element according to the present invention will be described with reference to accompanying drawings. In addition, in each drawing, a common symbol is assigned to a same member or portion, and a redundant description will be omitted.

### First Preferred Embodiment

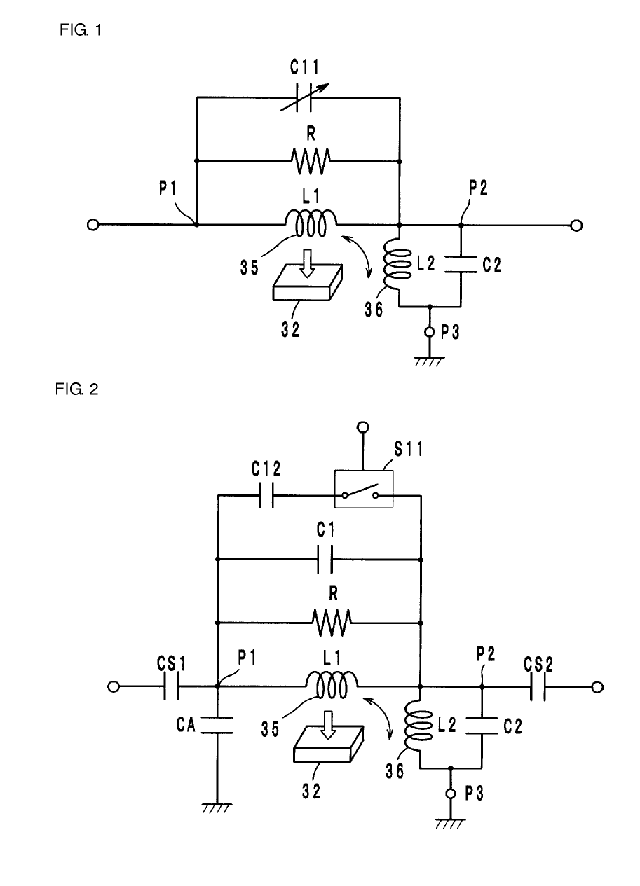

As illustrated in FIG. 1, a non-reciprocal circuit element (2-port type isolator) serving as a first preferred embodiment includes a ferrite 32 to which a direct-current magnetic field is applied by a permanent magnet (not illustrated), and a first center electrode 35 (L1) and a second center electrode 36(L2), which are disposed in the ferrite 32 so as to intersect with each other in an insulated state. One end of the first center electrode 35 is connected to an input port P1, and the other end thereof is connected to an output port P2. One end of the second center electrode 36 is connected to an output port P2, and the other end thereof is connected to a ground port P3. A terminating resistor R is connected in parallel to the first center electrode 35 between the input port P1 and the output port P2, a capacitance-variable capacitor C11 is connected between the input port P1 and the output port P2, and a matching capacitor C2 is connected between the output port P2 and the ground port P3.

In this non-reciprocal circuit element, when a high-frequency wave current is input from the output port P2, the high-frequency wave current is attenuated (isolation) by a parallel resonance circuit defined by the first center electrode 35 and the capacitance-variable capacitor C11. By changing the capacitance value of the capacitance-variable capacitor C11, an isolation frequency is adjusted. In addition, by selecting the impedance of the terminating resistor R, an attenuation is adjusted. On the other hand, at the time of an operation where a high-frequency wave current flows from the input port P1 to the output port P2, a large high-frequency wave current flows in the second center electrode 36, and high-frequency wave currents hardly flow in the terminating resistor R and the capacitance-variable capacitor C11. Therefore, even if the capacitance-variable capacitor C11 is added, a loss due thereto is negligible, and an insertion loss does not increase.

In addition, as for the capacitance-variable capacitor C11, the capacitance value thereof may be changeable in a stepwise fashion or the capacitance value may also be continuously changeable.

### Second Preferred Embodiment

As illustrated in FIG. 2, in a non-reciprocal circuit element (2-port type isolator) according to a second preferred embodiment of the present invention, a terminating resistor R and a first matching capacitor C1 are connected in parallel to the first center electrode 35, impedance matching capacitors CS1 and CA are connected on an input port P1 side, an impedance matching capacitor CS2 is connected on an output port P2 side, and furthermore, an adjusting capacitor C12 and a switching element S11 used to switch between an on-state and an off-state of the capacitor C12 are connected in parallel to the first center electrode 35 and the terminating resistor R. The other configuration is preferably the same or substantially the same as the first preferred embodiment. In addition, the characteristics of the present second preferred embodiment will be described with reference to FIG. 9 to FIG. 12.

In this non-reciprocal circuit element, when a high-frequency wave current is input from the output port P2, the high-frequency wave current is attenuated (isolation) by a parallel resonance circuit defined by the first center electrode 35, the first matching capacitor C1, and the adjusting capacitor C12. The switching element S11 changes the on-state or the off-state of the capacitor C12, and hence, an isolation frequency is adjusted. In addition, by selecting the impedance of the terminating resistor R, an attenuation is adjusted. On the other hand, at the time of an operation where a high-frequency wave current flows from the input port P1 to the output port P2, a large high-frequency wave current flows in the second center electrode 36, and high-frequency wave currents hardly flow in the terminating resistor R and the first matching capacitor C1 or the adjusting capacitor C12. Therefore, even if the capacitor C12 and the switching element S11 are added, a loss due thereto is negligible, and an insertion loss does not increase.

### Third Preferred Embodiment

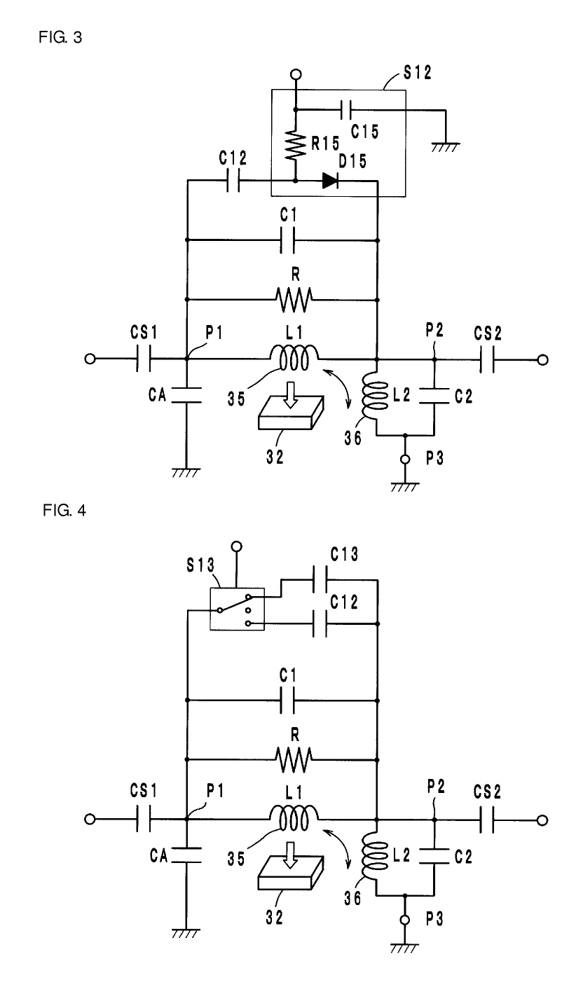

As illustrated in FIG. 3, a non-reciprocal circuit element (2-port type isolator) according to a third preferred embodiment is a non-reciprocal circuit element where the switching element S11 illustrated in the second preferred embodiment is configured as a semiconductor switch S12. The semiconductor switch S12 is well known as an SPST switch including a diode D15, a resistor R15, and a capacitor C15. The other configuration is preferably the same or substantially the same as the second preferred embodiment, and the functional effects thereof are the same as that described in the second preferred embodiment. In addition, as the switching element, an SPDT switch, a MEMS switch, or the like may also be used.

### Fourth Preferred Embodiment

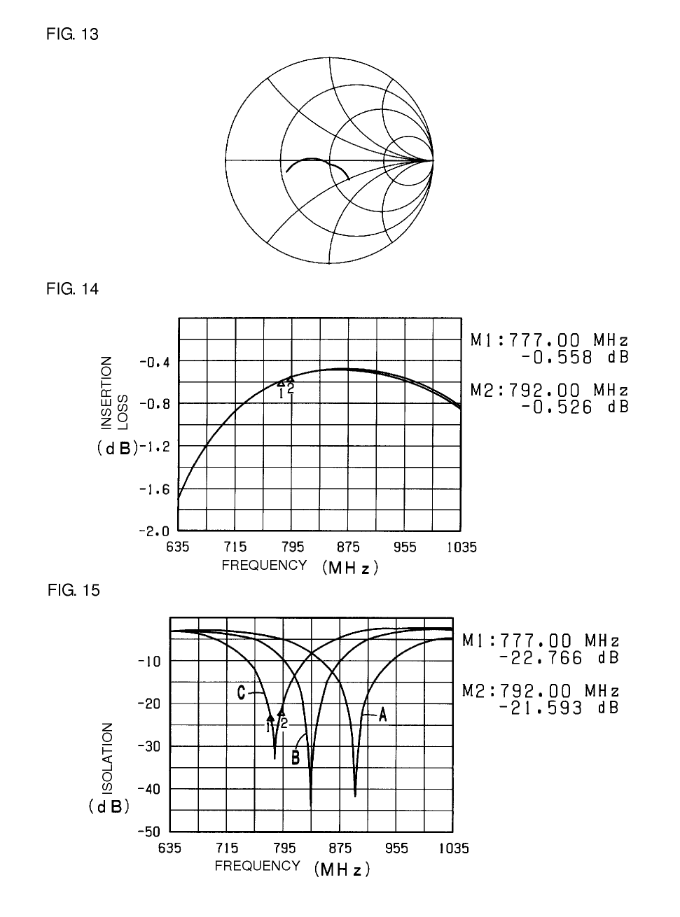

As illustrated in FIG. 4, a non-reciprocal circuit element (2-port type isolator) according to a fourth preferred embodiment of the present invention is a non-reciprocal circuit element where another adjusting capacitor C13 is added in parallel to the adjusting capacitor C12 and a switching element S13 used to switch between on-states and off-states of the two adjusting capacitors C12 and C13 is connected. The switching element S13 individually switches between the on-states and the off-states of the two adjusting capacitors C12 and C13 and may also select a neutral position. As the switching element, an SPDT switch, a MEMS switch, or the like may also be used. In the present fourth preferred embodiment, an adjusting capacitance value may be switchable among three stages. The other configuration is preferably the same or substantially the same as the second preferred embodiment, and the functional effects thereof are basically the same as the second preferred embodiment. In addition, the characteristics of the present fourth preferred embodiment will be described with reference to the following FIG. 13 to FIG. 16.

### Example 1 of Configuration of Non-Reciprocal Circuit Element

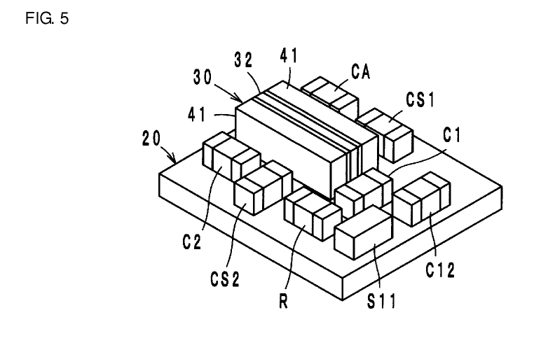

Here, an example 1 of a configuration of the non-reciprocal circuit element according to the second preferred embodiment of the present invention will be described with reference to FIG. 5. In this non-reciprocal circuit element, on a circuit substrate 20, a ferrite-magnet element 30 is mounted where both sides of the ferrite 32 in which the first and second center electrodes (not illustrated) are formed using a conductor film are fixed by a pair of permanent magnets 41 through an adhesive layer 42. Various kinds of elements C1, C2, CS1, CS2, CA, C12, S11, and R configuring the matching circuit and the resonant circuit are individually configured as chip types, and mounted on the circuit substrate 20. By arranging the electrodes and conductors in the surface and the inside of the circuit substrate 20 in a multilayer lamination, these elements are electrically connected so as to define the equivalent circuit illustrated in FIG. 2.

### Example 2 of Configuration of Non-Reciprocal Circuit Element

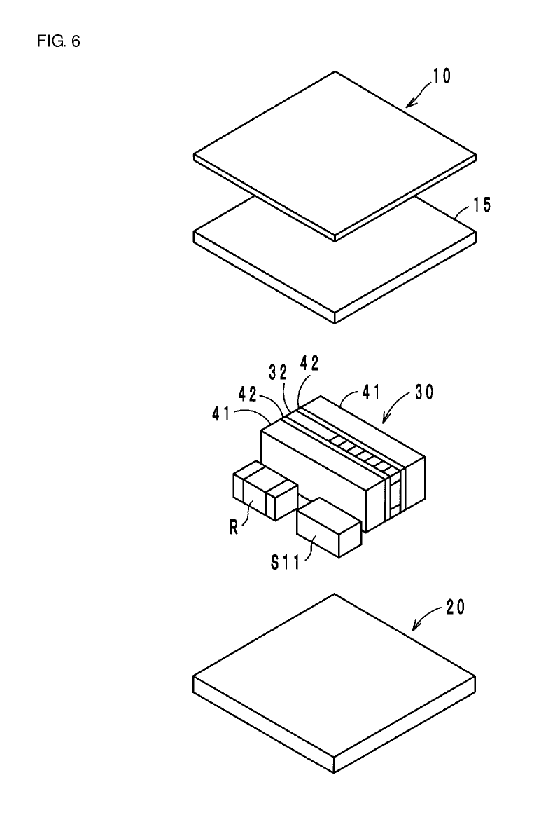

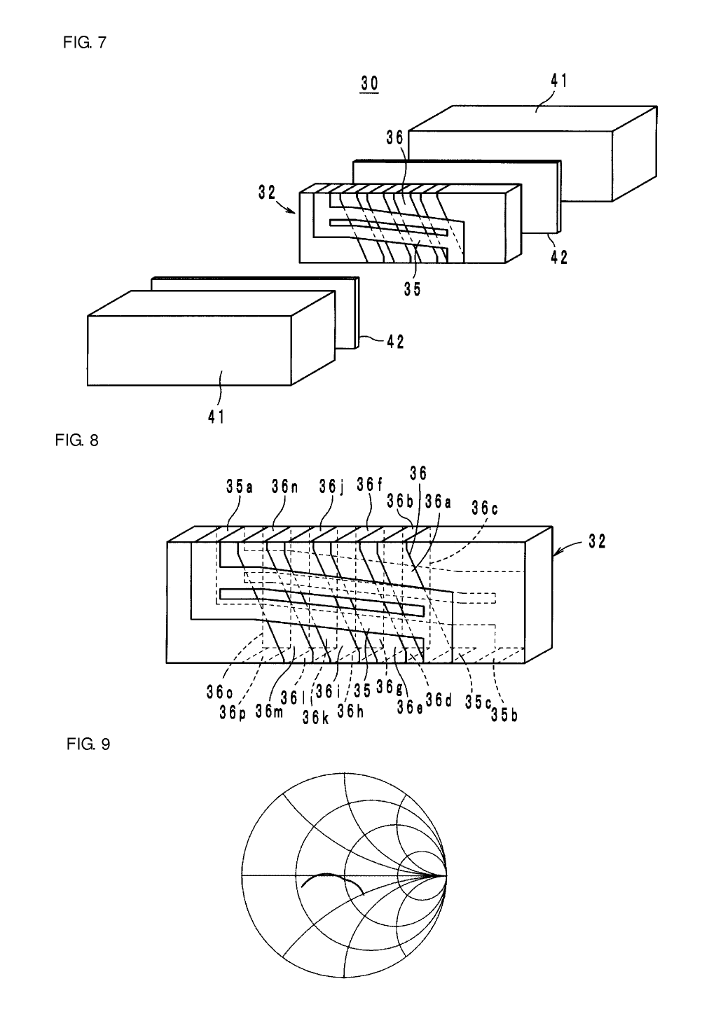

Next, an example 2 of a configuration of the non-reciprocal circuit element according to the second preferred embodiment of the present invention will be described with reference to FIG. 6. In this non-reciprocal circuit element, the ferrite-magnet element 30 is mounted on the circuit substrate 20, and as chip type components, the terminating resistor R and the switching element S11 are mounted on the circuit substrate 20. The other elements C1, C2, CS1, CS2, CA, and C12 are defined by electrodes or the like provided within the circuit substrate 20 subjected to multilayer lamination.

In addition, on the ferrite-magnet element 30, a flat plate-shaped yoke 10 is disposed through an adhesive layer 15 so as to perform magnetic shielding.

### Configuration of Ferrite-Magnet Element

A first center electrode 35 and a second center electrode 36 are wound around the ferrite 32 in a state of being electrically insulated from each other. Through, for example, the epoxy based adhesive layer 42, the permanent magnet 41 is bonded so as to apply a direct-current magnetic field to the ferrite 32 in a thickness direction.

The first center electrode 35 is preferably defined by a conductor film. As illustrated in FIG. 8, the first center electrode 35 is arranged so as to be inclined toward the upper left at a relatively small angle with respect to a long side in a state of rising from the lower right and branching into two on a front surface side of the ferrite 32, rises toward the upper left, goes around to a back surface side through a relay electrode 35a in a top surface, and branches into two on the back surface side so as to overlap with the front surface side in a see-through state, and one end thereof is connected to a connection electrode 35b formed in a bottom surface. In addition, the other end of the first center electrode 35 is connected to a connection electrode 35c formed in the bottom surface. In this way, the first center electrode 35 is wound around the ferrite 32 by one turn. In addition, the first center electrode 35 and the second center electrode 36 to be described later intersect with each other in a state of being isolated from each other with an insulation film being disposed therebetween.

The second center electrode 36 is defined by a conductor film. First, portion 36a at a half is inclined from the lower right toward the upper left at a relatively large angle with respect to the long side and intersecting with the first center electrode 35 on the front surface side, goes around to the back surface side through a relay electrode 36b in the top surface, and portion 36c at one turn substantially perpendicularly intersects with the first center electrode 35 on the back surface side. A lower end portion of the 36c at the one turn goes around to the front surface side through a relay electrode 36d in the bottom surface, and portion 36e at the one turn and a half intersects with the first center electrode 35 on the front surface side, and goes around to the back surface side through a relay electrode 36f in the top surface. Hereinafter, in the same way, portion 36g at two turns, a relay electrode 36h, portion 36i at the two turns and a half, a relay electrode 36j, 36k at three turns, a relay electrode 36l, portion 36m at the three turns and a half, a relay electrode 36n, and portion 36o at four turns are individually formed in the front and back surfaces and the top and bottom surfaces of the ferrite 32. In addition, both ends of the second center electrode 36 are individually connected to the connection electrodes 35c and 36p formed in the bottom surface of the ferrite 32. In addition, the connection electrode 35c is used as a connection electrode for an end portion of each of the first center electrode 35 and the second center electrode 36.

In other words, the second center electrode 36 turns out to be wound around the ferrite 32 by four turns in a spiral shape. Here, the number of turns is calculated based on a condition that a state where the center electrode 36 goes across one of the top and back surfaces once corresponds to a half turn. In addition, the intersecting angle between the center electrodes 35 and 36 is set as necessary, and input impedance and an insertion loss turn out to be adjusted. In this way, by the second center electrode 36 being wound around the ferrite 32 more than once, the inductance of the second center electrode 36 increase, the insertion loss decreases, and an operating frequency bandwidth is also magnified.

### Characteristics of Second Preferred Embodiment

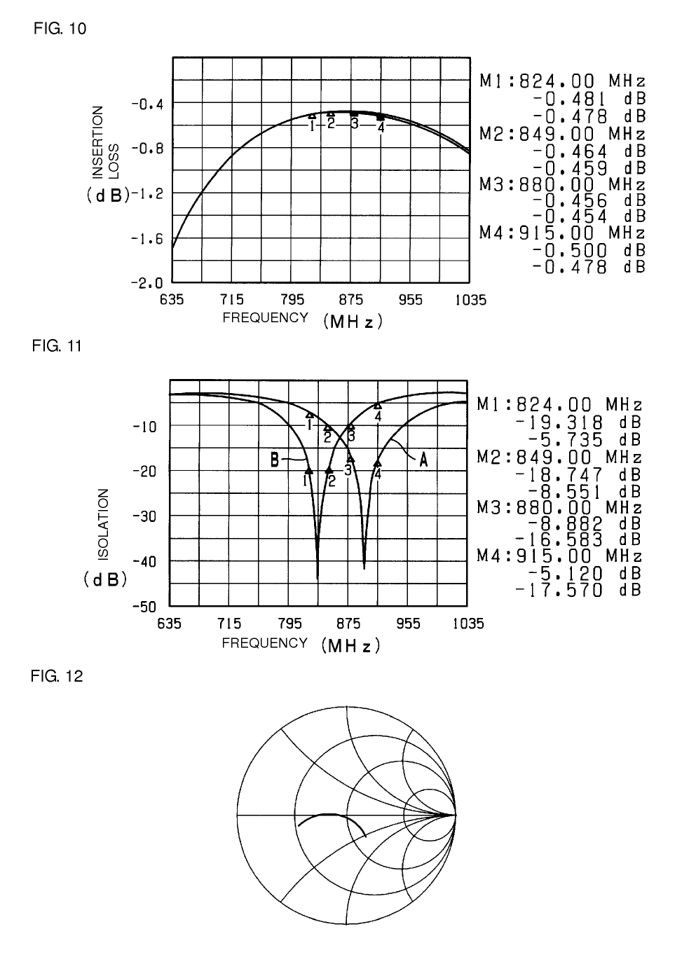

The characteristics of the second preferred embodiment (refer to FIG. 2) are illustrated in FIG. 9 to FIG. 12. FIG. 9 illustrates input matching characteristics, and FIG. 10 illustrates an insertion loss in a forward direction. While FIG. 9 and FIG. 10 illustrate a case where the adjusting capacitor C12 is turned on (a case where the capacitors C1 and C12 function as balancing capacitance) and a case where the adjusting capacitor C12 is turned off (a case where only the capacitor C1 functions), curved lines indicating characteristics nearly overlap with each other in each of the drawings, and an influence to the insertion of the capacitor C12 does not occur.

FIG. 11 illustrates an isolation characteristic in an inverse direction, and FIG. 12 illustrates output matching characteristics. In FIG. 11, an isolation characteristic when the adjusting capacitor C12 is turned off is illustrated by a curved line A, and an isolation characteristic when the adjusting capacitor C12 is turned on is illustrated by a curved line B. The capacitor C12 is turned on, and hence, an isolation frequency is shifted to a lower frequency band. In other words, while the isolation characteristic is Band8 (880 MHz to 915 MHz) when the capacitor C12 is turned off, the isolation characteristic is shifted to Band5 (824 MHz to 849 MHz) when the capacitor C12 is turned on. FIG. 12 also illustrates the case where the capacitor C12 is turned on and the case where the capacitor C12 is turned off, curved lines indicating characteristics nearly overlap with each other.

### Characteristics of Fourth Preferred Embodiment

The characteristics of the fourth preferred embodiment of the present invention (refer to FIG. 4) are illustrated in FIG. 13 to FIG. 16. FIG. 13 illustrates input matching characteristics, and FIG. 14 illustrates an insertion loss in a forward direction. While FIG. 13 and FIG. 14 illustrate a case where the adjusting capacitors C12 and C13 are turned off (a case where only the capacitor C1 functions), a case where the adjusting capacitor C12 is turned on (a case where the capacitors C1 and C12 function as a parallel capacitance), and a case where the adjusting capacitor C13 is turned on (a case where the capacitors C1 and C13 function as a parallel capacitance), curved lines indicating characteristics nearly overlap with one another in each of the drawings, and an influence to the insertion of the capacitors C12 and C13 does not occur.

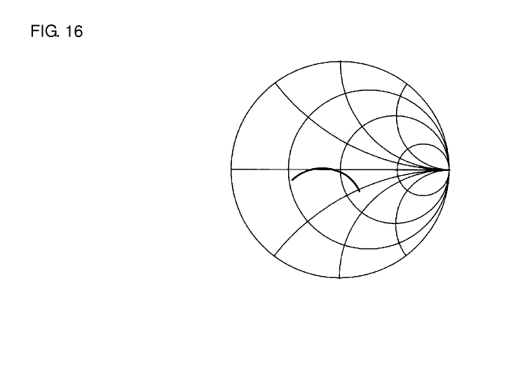

FIG. 15 illustrates an isolation characteristic in an inverse direction, and FIG. 16 illustrates output matching characteristics. In FIG. 15, an isolation characteristic when the adjusting capacitors C12 and C13 are turned off is illustrated by a curved line A, an isolation characteristic when the adjusting capacitor C12 is turned on is illustrated by a curved line B, and an isolation characteristic when the adjusting capacitor C13 is turned on is illustrated by a curved line C. The capacitors C12 and C13 are turned on, and hence, an isolation frequency is shifted to a lower frequency band. In other words, while the isolation characteristic is Band8 (880 MHz to 915 MHz) when the capacitors C12 and C13 are turned off, the isolation characteristic is shifted to Band5 (824 MHz to 849 MHz) when the capacitor C12 is turned on, and the isolation characteristic is shifted to Band13 (777 MHz to 792 MHz) when the capacitor C13 is turned on. FIG. 16 also illustrates the case where the capacitors C12 and C13 are selectively turned on and the case where the capacitors C12 and C13 are selectively turned off, curved lines indicating characteristics nearly overlap with one another.

### Another Preferred Embodiment

In addition, a non-reciprocal circuit element according to the present invention is not limited to the above-described preferred embodiments, and various modifications may occur within the scope thereof.

For example, if the north pole and the south pole of the permanent magnet 41 are inverted, the input port P1 and the output port P2 replace each other. In addition, the configuration of the ferrite-magnet element 30 and the shapes of the first and second center electrodes 35 and 36 may be variously changed.

Furthermore, as the configuration of a non-reciprocal circuit element, it may also be possible to adopt a configuration where first and second center electrodes are disposed on one main surface of a flat plate-shaped ferrite in a state of intersecting with each other with a predetermined angle (for example, described in detail in Japanese Unexamined Patent Application Publication No. 9-232818).

As described above, preferred embodiments of the present invention are useful for a non-reciprocal circuit element, and, in particular, superior in terms of adjusting an isolation frequency without deteriorating an insertion loss.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A non-reciprocal circuit element comprising:
a permanent magnet;
a ferrite to which a direct-current magnetic field generated by the permanent magnet is applied;
a plurality of center electrodes disposed in the ferrite so as to intersect with each other in an insulated state;
a terminating resistor connected in parallel to one of the center electrodes between input-output ports; and
a capacitance mechanism including a capacitance that is variable connected to the terminating resistor between the input-output ports.

2. The non-reciprocal circuit element according to claim 1, wherein the capacitance mechanism includes a capacitance-variable capacitor.

3. The non-reciprocal circuit element according to claim 1, wherein the capacitance mechanism includes at least one capacitor and a switching element that switches between an on-state and an off-state of the capacitor.

4. The non-reciprocal circuit element according to claim 1, wherein the capacitance mechanism includes a plurality of capacitors connected in parallel and a switching element that switches between an on-state and an off-state of each of the capacitors.

5. The non-reciprocal circuit element according to claim 1, wherein the ferrite has a flat plate-shaped body and the first and second center electrodes are disposed on a main surface of the flat plate-shaped body so as to intersect with each other.

6. The non-reciprocal circuit element according to claim 2, wherein the capacitance of the capacitance-variable capacitor is variable in a stepwise manner or in a continuous manner.

7. A non-reciprocal circuit element comprising:
a permanent magnet;
a ferrite to which a direct-current magnetic field generated by the permanent magnet is applied; and
a first center electrode and a second center electrode disposed in the ferrite so as to intersect with each other in an insulated state; wherein
one end of the first center electrode is electrically connected to an input port and the other end thereof is electrically connected to an output port;
one end of the second center electrode is electrically connected to an output port and the other end thereof is electrically connected to a ground port;
a terminating resistor is electrically connected between the input port and the output port;
a capacitance mechanism including a capacitance that is variable is connected in parallel to the terminating resistor between the input port and the output port; and
a matching capacitance is electrically connected between the output port and the ground port.

8. The non-reciprocal circuit element according to claim 7, wherein the second center electrode is wound around the ferrite more than once.

9. The non-reciprocal circuit element according to claim 7, wherein the capacitance mechanism includes a capacitance-variable capacitor.

10. The non-reciprocal circuit element according to claim 7, wherein the capacitance mechanism includes at least one capacitor and a switching element that switches between an on-state and an off-state of the capacitor.

11. The non-reciprocal circuit element according to claim 7, wherein the capacitance mechanism includes a plurality of capacitors connected in parallel and a switching element that switches between an on-state and an off-state of each of the capacitors.

12. The non-reciprocal circuit element according to claim 7, wherein the ferrite has a flat plate-shaped body and the first and second center electrodes are disposed on a main surface of the flat plate-shaped body so as to intersect with each other.

13. The non-reciprocal circuit element according to claim 9, wherein the capacitance of the capacitance-variable capacitor is variable in a stepwise manner or in a continuous manner.

14. A non-reciprocal circuit element comprising:
a permanent magnet;
a ferrite to which a direct-current magnetic field generated by the permanent magnet is applied; and
a first center electrode and a second center electrode configured to be disposed in the ferrite so as to intersect with each other in an insulated state; wherein
one end of the first center electrode is electrically connected to an input port and the other end thereof is electrically connected to an output port;
one end of the second center electrode is electrically connected to an output port and the other end thereof is electrically connected to a ground port;
a first matching capacitance is electrically connected between the input port and the output port;
a second matching capacitance is electrically connected between the output port and the ground port;
a terminating resistor is electrically connected between the input port and the output port; and
a capacitance mechanism including a capacitance that is variable is connected in parallel to the terminating resistor between the input port and the output port.

15. The non-reciprocal circuit element according to claim 14, wherein the second center electrode is wound around the ferrite more than once.

16. The non-reciprocal circuit element according to claim 14, wherein the capacitance mechanism includes a capacitance-variable capacitor.

17. The non-reciprocal circuit element according to claim 14, wherein the capacitance mechanism includes at least one capacitor and a switching element that switches between an on-state and an off-state of the capacitor.

18. The non-reciprocal circuit element according to claim 14, wherein the capacitance mechanism includes a plurality of capacitors connected in parallel and a switching element that switches between an on-state and an off-state of each of the capacitors.

19. The non-reciprocal circuit element according to claim 14, wherein the ferrite has a flat plate-shaped body and the first and second center electrodes are disposed on a main surface of the flat plate-shaped body so as to intersect with each other.

20. The non-reciprocal circuit element according to claim 16, wherein the capacitance of the capacitance-variable capacitor is variable in a stepwise manner or in a continuous manner.
